(19) United States
(12) Patent Application Publication
(10) Pub. No.: US 2023/0134857 A1
(43) Pub. Date: May 4, 2023

(54) LENS FOREIGN OBJECT DETECTION HEATER AND CAMERA DEVICE

(71) Applicant: SAMSUNG ELECTRO-MECHANICS CO., LTD., Suwon-si (KR)

(72) Inventor: Jae Chan LEE, Suwon-si (KR)

(73) Assignee: SAMSUNG ELECTRO-MECHANICS CO., LTD., Suwon-si (KR)

(21) Appl. No.: 17/951,166

(22) Filed: Sep. 23, 2022

(30) Foreign Application Priority Data
Nov. 3, 2021 (KR) 10-2021-0149609

(51) Int. Cl. G03B 17/55; H04N 5/225

(52) U.S. Cl. CPC G03B 17/55; H04N 5/22521; H04N 5/2253; H04N 5/2254

(57) ABSTRACT

A lens foreign object detection heater includes a sensor disposed inside an external lens, to generate a sensing signal when a foreign object is present on the external lens, a heater disposed on the external lens, and operated by receiving driving power, a detector generating a trigger signal based on the sensing signal, and generating a detection signal based on the trigger signal, and a power controller supplying or blocking driving power to the heater in response to the detection signal.

### CROSS-REFERENCE TO RELATED APPLICATIONS

This application claims the benefit under 35 USC 119(a) of Korean Patent Application No. 10-2021-0149609 filed on Nov. 3, 2021, in the Korean Intellectual Property Office, the entire disclosure of which is incorporated herein by reference for all purposes.

### BACKGROUND

### 1. Field

The present disclosure relates to a lens foreign object detection heater and a camera device.

### 2. Description of the Background

In general, with the development of advanced driver assistance system (ADAS) technology, applied to a vehicle and providing driver convenience, sensing of various situations that may occur during actual driving, such as a technology for distance recognition and object classification such as cameras, lidar, and radar, may be considered.

In the case of the camera, object classification may be the most accurate method, and it is a good solution to determine a distance between objects such as to the rear and front, but there are limitations in use thereof in bad weather or low light conditions, and attempts to overcome this are in progress. In particular, if a lens surface of the camera is covered in the case of snow or rain, there is a disadvantage in that an ability to recognize objects, which is an advantage of a camera, is lowered.

In order to solve this disadvantage, in the prior art, a method of transferring heat by winding a hot wire around the camera was adopted, or there was an example in which an indium tin oxide (ITO) transparent electrode or a flexible heating substrate was applied by wrapping a lens barrel with an electrical wiring disposed on a flexible film, or adding one more glass covers to the lens.

In such an existing structure, problems such as camera performance degradation (distortion, reduced viewing angle, and the like) due to extreme temperature changes or added glass covers still exist, a module structure becomes complicated, and a manufacturing cost thereof increases.

In addition, as autonomous driving becomes an issue, the use of a sensing camera is increasing, and when foreign objects are present on a surface of the lens, there is a problem in that detection ability is deteriorated.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lens foreign object detection heater includes a sensor disposed inside an external lens, to generate a sensing signal when a foreign object is present on the external lens, a heater disposed on the external lens, and operated by receiving driving power, a detector generating a trigger signal based on the sensing signal, and generating a detection signal based on the trigger signal, and a power controller supplying or blocking driving power to the heater in response to the detection signal.

The sensor may include a sensing coil for outputting the sensing signal based on electromotive force induced when a foreign object is present on the external lens.

The heater may include a heating coil operated by driving power supplied under the control of the power controller, to heat the external lens.

The lens foreign object detection heater may further include a blocking unit disposed between the sensing coil and the heating coil to isolate the sensing coil and the heating coil from each other.

The detector may include an amplification circuit amplifying the sensing signal to generate the trigger signal, and a detection circuit generating the detection signal having a first level for a predetermined time based on the trigger signal.

The amplification circuit may include an amplifier amplifying the sensing signal to provide an amplified signal, and a comparison circuit comparing the amplified signal with a reference voltage and generating the trigger signal having the first level when a voltage level of the amplified signal is higher than the reference voltage.

The detection circuit may include a timer generating the detection signal maintaining the first level for a certain period of time, when the trigger signal is input.

The power controller may include a switch supplying driving power to the heater, based on the detection signal.

In another general aspect, a camera device includes a lens foreign object detection heater including an external lens, and a camera lens module coupled to the lens foreign object detection heater, the camera lens module including a lens module, wherein the lens foreign object detection heater includes a sensor disposed inside the external lens, to generate a sensing signal when a foreign object is present on the external lens, a heater disposed on the external lens, and operated by receiving driving power, a detector generating a trigger signal based on the sensing signal, and generating a detection signal using the trigger signal, and a power controller supplying or blocking driving power to the heater in response to the detection signal.

The amplification circuit may include an amplifier amplifying the sensing signal to provide an amplified signal, and a comparison circuit comparing the amplification signal with a reference voltage, to generate the trigger signal having the first level when a voltage level of the amplification signal is higher than the reference level.

In another general aspect, a lens foreign object detection heater includes a sensing coil, a detector configured to detect an induced electromotive force in the sensing coil, an external lens disposed on the sensing coil, a heater configured to heat the external lens, and a power controller configured to control the heater to selectively heat the external lens, wherein a touch of the external lens by a foreign object changes the induced electromotive force of the sensing coil detected by the detector, and the power controller controls the heater to selectively heat the external lens in response to the detected change in the induced electromotive force.

The power controller may control the heater to heat the external lens in response to the detected change in the induced electromotive force being greater than a predetermined reference level.

The lens foreign object detection heater may further include a blocking unit. The heater may include a heating coil disposed between the sensing coil and the external lens. The blocking unit may be disposed between the sensing coil and the heating coil to isolate the sensing coil and the heating coil from each other.

A camera device may include the lens foreign object detection heater, and a camera lens module coupled to the lens foreign object detection heater, wherein the camera lens module may include a housing and a lens module disposed in the housing.

Other features and aspects will be apparent from the following detailed description, the drawings, and the claims.

### BRIEF DESCRIPTION OF THE DRAWINGS

FIG. 1 is an example view of a lens foreign object detection heater according to an embodiment of the present disclosure.

FIG. 2 is an example view of a camera device according to an embodiment of the present disclosure.

FIG. 3 is a detailed example view of the lens foreign object detection heater of FIG. 1.

FIG. 4 is an example view of a sensor.

FIG. 5 is an example view of a sensing signal for a foreign object.

FIG. 6 is an example view of an amplification circuit.

FIG. 7 is an example view of a sensing signal and a trigger signal.

FIG. 8 is an example view of a detection circuit unit.

FIG. 9 is an example view of a power controller.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure is to provide a lens foreign object detection heater and a camera device capable of sensing and removing foreign objects in a lens by automatically detecting a minute change according to foreign objects in the lens.

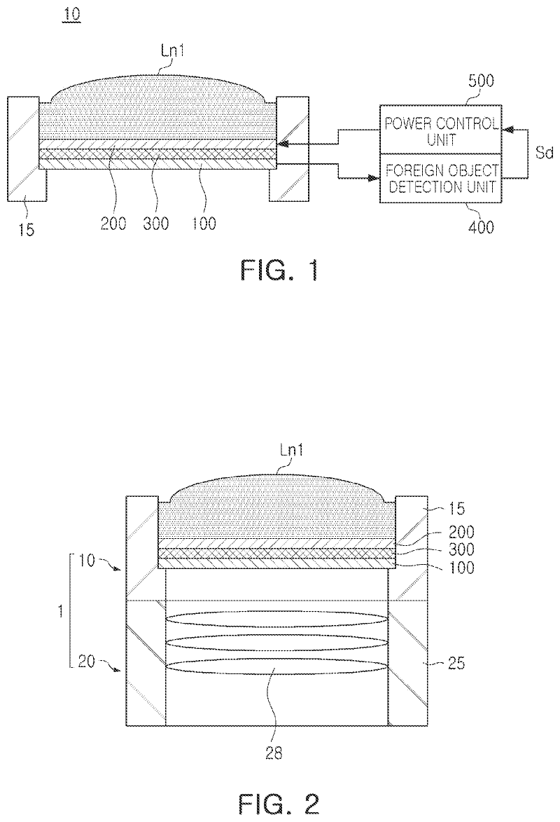

FIG. 1 is an example view of a lens foreign object detection heater according to an embodiment of the present disclosure.

Referring to FIG. 1, a lens foreign object detection heater 10 according to an embodiment of the present disclosure may include a sensor 100, a heater 200, a detector 400 to detect a foreign object, and a power controller 500, incorporated into a housing 15.

FIG. 2 is an example view of a camera device according to an embodiment of the present disclosure.

Referring to FIG. 2, a camera device 1 according to an embodiment of the present disclosure may include a lens foreign object detection heater 10 and a camera lens module 20.

The lens foreign object detection heater 10 may include an external lens Ln1, a sensor 100, a heater 200, a detector 400, and a power controller 500, incorporated into a heater housing 15.

The camera lens module 20 may include a lens module 28 coupled to the lens foreign object detection heater 10 and incorporated into a lens housing 25.

For example, the lens module 28 may include a plurality of lenses.

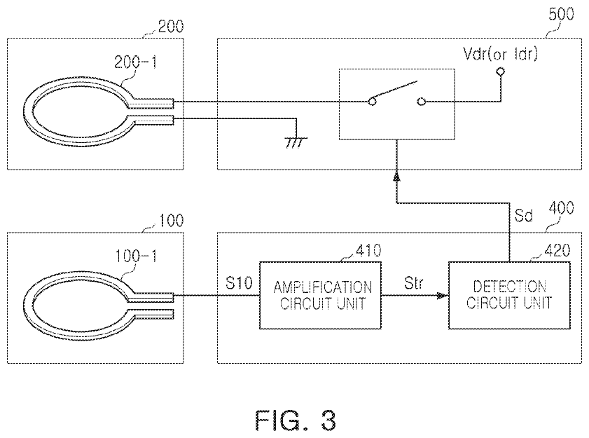

Referring to FIGS. 1 and 2, the sensor 100 may be disposed inside the external lens Ln1, to generate a sensing signal S10 (FIG. 3) when a foreign object is present on the external lens Ln1. Here, the foreign object may be a material covering the external lens Ln1, for example, snow or water droplets. For example, an external surface of the external lens Ln1 may be coated with a transparent film such as ITO.

The heater 200 may be disposed on the external lens Ln1, and may be operated by receiving driving power. As an example, the heater 200 may include a component generating heat.

The detector 400 may generate a trigger signal Str based on the sensing signal S10, and generate a detection signal Sd using the trigger signal Str.

The power controller 500 may supply or cut off driving power to the heater 200 in response to the detection signal Sd.

With respect to each drawing of the present disclosure, unnecessary redundant descriptions of the same reference numerals and components having the same function may be omitted, and possible differences may be described with respect to each drawing.

FIG. 3 is a detailed example view of the lens foreign object detection heater of FIG. 1.

Referring to FIG. 3, for example, the sensor 100 may include a sensing coil 100-1. The sensing coil 100-1 may output the sensing signal S10 based on electromotive force induced when a foreign object is present on the external lens Ln1.

For example, the foreign object may be water, ice, soil, and the like having a predetermined dielectric constant, and the sensing coil 100-1 may be formed in a helical shape, a spiral shape, or a mendline shape, but an embodiment thereof is not limited thereto.

For example, when a foreign object is disposed on or attached to the external lens Ln1, a dielectric constant of the foreign object is added to a dielectric constant of the external lens to change an overall dielectric constant, and an electric field is changed due to this change in the dielectric constant, thereby changing induced electromotive force. As described above, a foreign object may be detected based on the change in the induced electromotive force.

The heater 200 may include, for example, a heating coil 200-1. The heating coil 200-1 may operate by driving power supplied under the control of the power controller 500, to heat the external lens Ln1. Here, the driving power may be a driving voltage Vdr or a driving current Idr.

For example, the power controller 500 may supply driving power up to 3 to 12V in order to match a desired temperature and temperature increase rate, and the driving power may be provided using an external power source such as an internal camera module, an ECU of a vehicle, or the like.

For example, the detector 400 may include an amplification circuit 410 and a detection circuit 420.

The amplification circuit 410 may amplify the sensing signal S10 to generate a trigger signal Str.

The detection circuit 420 may generate the detection signal Sd having a high level (a first level) or a detection signal Sd having a low level (a second level lower than the first level) for a predetermined time based on the trigger signal Str.

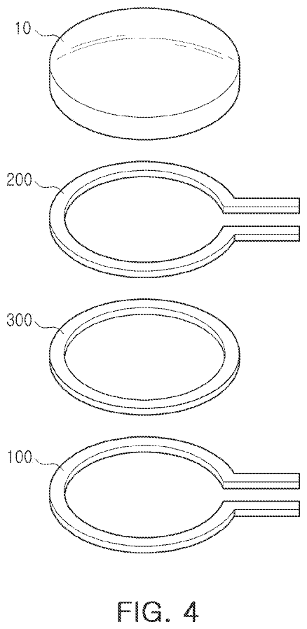

FIG. 4 is an example view of a sensor.

Referring to FIGS. 1, 2, and 4, the lens foreign object detection heater 10 may include a blocking unit 300.

For example, the blocking unit 300 may be disposed between the sensing coil 100-1 and the heating coil 200-1, for isolation.

For example, the blocking unit 300 may be formed of a material having an electrical insulating function, such as an insulating material, or the like.

For example, an external lens Ln1 may be disposed on an upper surface of a sensor 100, a blocking unit 300 may be disposed between a sensing coil 100-1 of the sensor 100 and a heating coil 200-1 of the heater 200, so that the sensing coil 100-1 and the heating coil 200-1 may be isolated from each other by the blocking unit 300, and accordingly, the sensing coil and the heating coil may perform respective functions independently without affecting each other.

For example, in order to increase thermal efficiency of the external lens Ln1, a heating coil 200-1 may be disposed adjacent to the external lens Ln1.

A power line supplying driving power to the heating coil 200-1 of the heater 200 may be disposed through a camera lens module 20.

As an example, a wiring for providing a sensing signal by sensing induced electromotive force that varies according to foreign objects may also be disposed through the camera lens module 20.

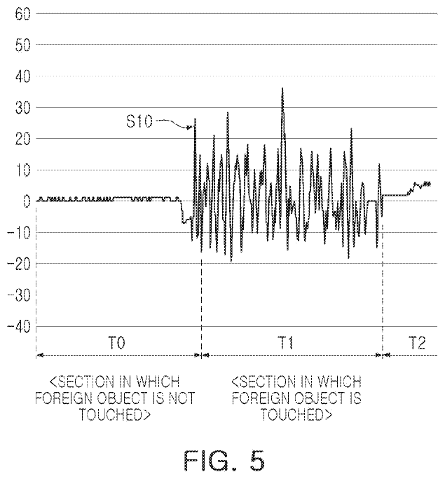

FIG. 5 is an example view of a sensing signal for a foreign object.

Referring to FIG. 5, a sensing signal S10 may be a signal maintained at a low level in sections T0 and T2 in which a foreign object is not touched, and a signal having a level that drastically changes into negative (−) and positive (+) levels, in a section T1 in which a foreign object is touched.

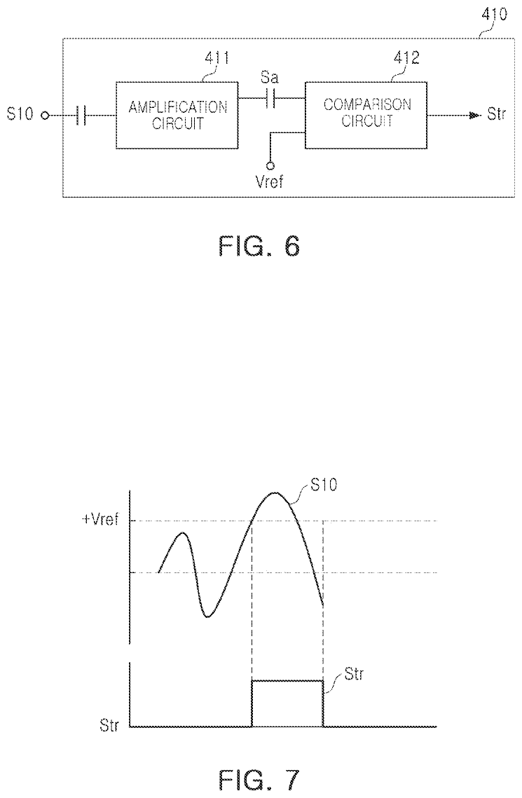

FIG. 6 is an example view of an amplification circuit.

Referring to FIG. 6, the amplification circuit 410 may include an amplifier 411 and a comparison circuit 412.

The amplifier 411 may amplify the sensing signal S10 to provide an amplified signal Sa.

The comparison circuit 412 may compare the amplified signal Sa with a reference voltage Vref, to generate the trigger signal Str having a high level, when a voltage level of the amplified signal Sa is higher than the reference voltage Vref, or to provide a trigger signal Str having a low level, when a voltage level of the amplified signal Sa is lower than the reference voltage Vref.

For example, the sensing signal S10 sensed by the sensor 100 may be amplified by the amplifier 411 of the detector 400, and the amplified signal Sa may be input to the comparison circuit 412.

The comparison circuit 412 may generate a trigger signal Str based on the amplified signal Sa and provide the same to a detection circuit 420.

For example, the comparison circuit 412 may compare the amplified signal Sa with a reference voltage Vref, and when a voltage level of the amplified signal Sa is higher than the reference voltage Vref, a foreign object is detected. In this case, the trigger signal Str having a high level may be generated. On the other hand, when the voltage level of the amplified signal Sa is not higher than the reference voltage Vref, no foreign object is detected. In this case, the comparison circuit 412 may generate a trigger signal Str having a low level.

Here, in the case of the trigger signal Str having a low level, the heater 200 may not operate.

FIG. 7 is an example view of a sensing signal and a trigger signal.

Referring to FIG. 7, the sensing signal S10 is output from the sensor 100, and may be a signal having a different level for each of when touch is performed and touch is not performed.

The trigger signal Str is output from the amplification circuit 410 (FIG. 3) to the comparison circuit 420 (FIG. 3), and when a magnitude of the sensing signal S10 is higher than a reference voltage (+Vref), it may be a signal having a high level, and when a magnitude of the sensing signal S10 is not higher than a reference voltage (+Vref), it may be a signal having a low level.

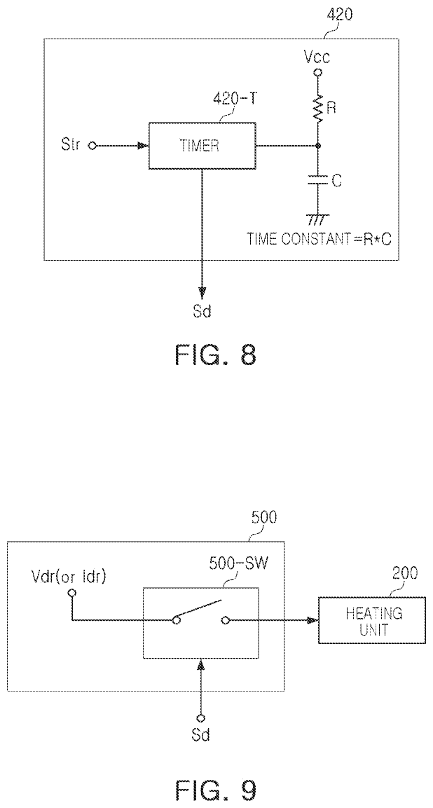

FIG. 8 is an example view of a detection circuit.

Referring to FIG. 8, as an example, the detection circuit 420 may include a timer 420-T. The timer 420-T may generate the detection signal Sd maintaining a high level for a predetermined time, when the trigger signal Str is input.

For example, the timer 420-T may generate a detection signal Sd maintained at a high level for a predetermined time according to a time constant (τ=R*C) determined by resistor R and a capacitor C.

To summarize the above-described process, for example, assuming that foreign objects such as rainwater, or the like, are attached to a surface of an external lens Ln1 (touch is performed), in the sensor 100, a sensing signal sensed by a sensing coil 100-1 may be amplified into a signal having a required magnitude at a rear end thereof through an amplification process by the amplification circuit 410.

An amplifier 411 of the amplification circuit 410 may stabilize instability that may be generated due to heat caused by the heater 200 or external environmental influences, and a comparison circuit 412 thereof may block a meaningless amplified signal Sa in advance using a reference voltage Vref to prevent malfunction of the heater 200.

Here, the reference voltage Vref may be provided through a resistor distribution circuit using an internal power source such as a camera module, an external power source such as a controller (ECU) of the vehicle, or the like.

FIG. 9 is an example view of a power controller.

Referring to FIG. 9, the power controller 500 may include a switch 500-SW. The switch 500-SW may supply driving power Vdr or Idr to the heater 200, based on the detection signal Sd.

For example, the power controller 500 may be a power source using an internal power source of an applied camera module, or if a rather large power source is required depending on the situation, the power controller 500 may be a power source using an external power source such as a controller of the vehicle (ECU), or the like.

As set forth above, according to an embodiment of the present disclosure, by automatically detecting a minute change according to a foreign object on a lens, it is possible to perform sensing and removal of the foreign object on the lens.

In other words, by amplifying a minute signal from a sensor and detecting a foreign object based on the amplified signal, there is an effect of automatically detecting and automatically removing the foreign object by operating a heater for removing the foreign object.

Accordingly, there is also an advantage that a processor such as a relatively expensive artificial intelligence (AI) processor is unnecessary.

The lens foreign object detection heater, sensor 100, heater 200, blocking unit 300, detector 400, power controller 500, processors, memories, sensing coil, heating coil, amplification circuit 410, amplifier 411, comparison circuit 412, detection circuit 420, timer, resistor, capacitor, switch 500-SW, and other apparatuses, devices, units, modules, and components described herein with respect to FIGS. 1-9 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions used herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD−Rs, CD+Rs, CD−RWs, CD+RWs, DVD-ROMs, DVD−Rs, DVD+Rs, DVD−RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens foreign object detection heater, comprising:
a sensor disposed inside an external lens, to generate a sensing signal when a foreign object is present on the external lens;
a heater disposed on the external lens, and operated by receiving driving power;
a detector generating a trigger signal based on the sensing signal, and generating a detection signal based on the trigger signal; and
a power controller supplying or blocking driving power to the heater in response to the detection signal.

2. The lens foreign object detection heater of claim 1, wherein the sensor comprises a sensing coil for outputting the sensing signal based on electromotive force induced when a foreign object is present on the external lens.

3. The lens foreign object detection heater of claim 2, wherein the heater comprises a heating coil operated by driving power supplied under the control of the power controller, to heat the external lens.

4. The lens foreign object detection heater of claim 3, further comprising:
a blocking unit disposed between the sensing coil and the heating coil to isolate the sensing coil and the heating coil from each other.

5. The lens foreign object detection heater of claim 1, wherein the detector comprises:
an amplification circuit amplifying the sensing signal to generate the trigger signal; and
a detection circuit generating the detection signal having a first level for a predetermined time based on the trigger signal.

6. The lens foreign object detection heater of claim 5, wherein the amplification circuit comprises,
an amplifier amplifying the sensing signal to provide an amplified signal; and
a comparison circuit comparing the amplified signal with a reference voltage and generating the trigger signal having the first level when a voltage level of the amplified signal is higher than the reference voltage.

7. The lens foreign object detection heater of claim 5, wherein the detection circuit comprises a timer generating the detection signal maintaining the first level for a certain period of time, when the trigger signal is input.

8. The lens foreign object detection heater of claim 7, wherein the power controller comprises a switch supplying driving power to the heater, based on the detection signal.

9. A camera device, comprising:
a lens foreign object detection heater including an external lens; and
a camera lens module coupled to the lens foreign object detection heater, the camera lens module including a lens module,
wherein the lens foreign object detection heater comprises:
a sensor disposed inside the external lens, to generate a sensing signal when a foreign object is present on the external lens;
a heater disposed on the external lens, and operated by receiving driving power;
a detector generating a trigger signal based on the sensing signal, and generating a detection signal using the trigger signal; and
a power controller supplying or blocking driving power to the heater in response to the detection signal.

10. The camera device of claim 9, wherein the sensor comprises a sensing coil for outputting the sensing signal based on electromotive force induced when a foreign object is present on the external lens.

11. The camera device of claim 10, wherein the heater comprises a heating coil operated by driving power supplied under the control of the power controller, to heat the external lens.

12. The camera device of claim 11, further comprising:
a blocking unit disposed between the sensing coil and the heating coil to isolate the sensing coil and the heating coil from each other.

13. The camera device of claim 9, wherein the detector comprises,
an amplification circuit amplifying the sensing signal to generate the trigger signal; and
a detection circuit generating the detection signal having a first level for a predetermined time based on the trigger signal.

14. The camera device of claim 13, wherein the amplification circuit comprises,
an amplifier amplifying the sensing signal to provide an amplified signal; and
a comparison circuit comparing the amplification signal with a reference voltage, to generate the trigger signal having the first level when a voltage level of the amplification signal is higher than the reference level.

15. The camera device of claim 13, wherein the detection circuit unit comprises a timer generating the detection signal maintaining the first level for a certain period of time, when the trigger signal is input.

16. The camera device of claim 9, wherein the power controller comprises a switch supplying driving power to the heater, based on the detection signal.

17. A lens foreign object detection heater, comprising:
a sensing coil;
a detector configured to detect an induced electromotive force in the sensing coil;
an external lens disposed on the sensing coil;
a heater configured to heat the external lens; and
a power controller configured to control the heater to selectively heat the external lens,
wherein a touch of the external lens by a foreign object changes the induced electromotive force of the sensing coil detected by the detector, and the power controller controls the heater to selectively heat the external lens in response to the detected change in the induced electromotive force.

18. The lens foreign object detection heater of claim 17, wherein the power controller controls the heater to heat the external lens in response to the detected change in the induced electromotive force being greater than a predetermined reference level.

19. The lens foreign object detection heater of claim 17, further comprising a blocking unit,
wherein the heater comprises a heating coil disposed between the sensing coil and the external lens, and
wherein the blocking unit is disposed between the sensing coil and the heating coil to isolate the sensing coil and the heating coil from each other.

20. A camera device, comprising:
the lens foreign object detection heater of claim 17; and
a camera lens module coupled to the lens foreign object detection heater, wherein the camera lens module comprises a housing and a lens module disposed in the housing.
